(19) United States
(12) Patent Application Publication
(10) Pub. No.: US 2026/0312964 A1
(43) Pub. Date: Oct. 8, 2026

(54) A DETECTION SYSTEM OF CYBER SECURITY INVENTORY

(71) Applicant: TURKCELL TEKNOLOJI ARASTIRMA VE GELISTIRME ANONIM SIRKETI, Istanbul (TR)

(72) Inventors: Mucahit OZTURK, Istanbul (TR); Cihan YUCEER, Istanbul (TR)

(73) Assignee: TURKCELL TEKNOLOJI ARASTIRMA VE GELISTIRME ANONIM SIRKETI, Istanbul (TR)

(21) Appl. No.: 19/485,110

(22) PCT Filed: Dec. 29, 2023
(86) PCT No.: PCT/TR2023/051832

§ 371 Date: Nov. 17, 2025

(30) Foreign Application Priority Data
May 17, 2023 (TR) 2023/005530

(51) Int. Cl. H04L 9/40

(52) U.S. Cl. CPC H04L 63/1416

(57) ABSTRACT

The present invention relates to a system (1) which is developed to detect log flow and cyber attacks carried out against services by extracting the lists of inventories that are unusable and/or invisible, upon identifying the critical inventories of enterprises that are open to the Internet from a cyber security perspective and then comparing them with the inventories that are known to exist.

### TECHNICAL FIELD

The present invention relates to a system for detecting log flow and cyber attacks carried out against services by extracting the lists of inventories that are unusable and/or invisible, upon identifying the critical inventories of enterprises that are open to the Internet from a cyber security perspective and then comparing them with the inventories that are known to exist.

### BACKGROUND OF THE INVENTION

Large-scale enterprises experience various difficulties in inventory management. In particular, due to the fact that services provided by institutions as open to the Internet are accessible by everyone, they may pose some risks. In order to reduce the risk, the services provided as open to the Internet are required to transfer their access logs to the cyber security centres of the institutions, otherwise situations where cyber attacks which may take place specific to the service-cannot be detected occur and since large-scale institutions contain many services open to the Internet, log transfer to cyber security centres may not occur for all services.

Therefore, it is understood that there is need for a system for detecting log flow and cyber attacks carried out against services by extracting the lists of inventories that are unusable and/or invisible, upon identifying the critical inventories of enterprises that are open to the Internet and then comparing them with the inventories that are known to exist

The Turkish patent document no. TR2022/020847, an application included in the state of the art, discloses a system which enables to carry out multiple analyses of traffic in different time periods and detection of integrated cyber security threat by means od artificial intelligence analysis, by being integrating with the data management products of institutions that provide cyber security services. The server included in the invention enables to make sense of all types of records stored in the database, to classify and report outputs according to the defined perspectives of users who may be analysts and administrators by performing integrated analysis in different time periods, to query the database in accordance with the specified time intervals and the user-specified parameters, and to detect the anomaly according to the threshold values specified by the user.

In the Turkish patent document no. TR2022/020847, an anomally detection is carrried out by connecting to an in-house data management product. However, it is not possible in the said invention to detect a service which has never sent logs to the data management product before but is open to the Internet, to compare the outputs based on the “t” moment connected to the work at the point of detecting critical assets, and to detect services that do not provide logs to the data management product.

### SUMMARY OF THE INVENTION

An objective of the present invention is to realize a system which provides a log flow by detecting services which are not visible and which are not monitored by a cyber security centre.

Another objective of the present invention is to realize a system which is developed to detect cyber attacks carrie out against services.

Another objective of the present invention is to realize a system which is developed to detect all services related to the institution by actively scanning over the Internet and to create a service inventory list.

Another objective of the present invention is to realize a system which is developed to detect and create a list of services that provide log flow from the log management product used within the institution to the cyber defence centre.

Another objective of the present invention is to realize a system which is developed to detect the services that provide outsourced services but do not flow logs to the cyber security centre log infrastructure by comparing the lists generated from different perspectives.

### DETAILED DESCRIPTION OF THE INVENTION

“A Detection System of Cyber Security Inventory” realized to fulfil the objectives of the present invention is shown in the figure attached, in which:

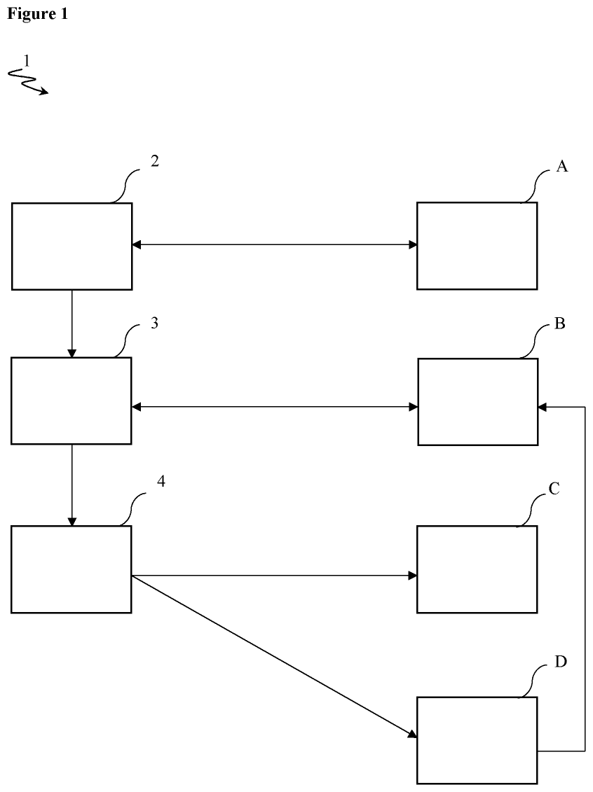

FIG. 1 is a schematic view of the inventive system.

The components illustrated in the figure are individually numbered, where the numbers refer to the following:
1. System
2. Scan Server
3. Detection Server
4. Notification Server
A. Enterprise Network
B. Logger
C. Security Operations Center (SOC)
D. Service Owner

The inventive system (1) which is developed to detect log flow and cyber attacks carried out against services by extracting the lists of inventories that are unusable and/or invisible, upon identifying the critical inventories of enterprises that are open to the Internet from a cyber security perspective and then comparing them with the inventories that are known to exist; comprises
at least one scan server (2) which is configured to detect the services that are open to the Internet by performing scans outside the network (A) of the enterprise and to extract an inventory list;
at least one detection server (3) which is configured to detect the services that provide log flow to the enterprise with the necessary queries from the logger (B) wherein all logs of the enterprise are collected;
at least one notification server (4) which is configured to compare the results received from the scan server (2) and the detection server (3), to detect the services that are running but not providing log streams, and to generate a notification to the owners of the related services (D) for necessary actions to be taken.

The scan server (2) included in the inventive system (1) is configured to detect the services of the enterprise that are open to the Internet. The scan server (2) is configured to perform scans that detect open services according to the returned responses, by sending a connection request from an external server-that is independent of the enterprise and has internet access-such that it covers all ports included in the known IP range of the enterprise. The scan server (2) is configured to generate an inventory list based on the scans that detect open services according to the responses returned by the connection request. The scan server (2) is configured to obtain the findings of the scan in the form of names of servers of the enterprise that are open to the Internet such as web, e-mail. The scan server (2) is configured to transmit the obtained findings to the detection server (3).

The detection server (3) included in the inventive system (1) is configured to detect the services that provide log flow by making the necessary queries in the logger (B) wherein all logs of the enterprise are collected. The detection server (3) is configured to extract an inventory of the enterprise by making queries to the logger (B). The detection server (3) is configured to perform a cross-query together with the findings obtained by the scan server (2) and the information obtained by itself. The detection server (3) is configured to detect the missing points by comparing information received from the logger (B) with information from the scan server (2). In one preferred embodiment of the invention, when a domain name such as “xyz. companyname. com” and a web server running behind it are detected as a result of the scans of the scan server (2), the detection server (3) is configured to make a mark when it does not detect this domain name in the information received over the logger (B). The detection server (3) is configured to transmit information to the notification server (4) for any service or inventory obtained as a result of the scan, but not found in the information received over the logger (B).

The notification server (4) included in the inventive system (1) is configured to transmit the information, transmitted from the detection server (3), to the security operations centre (C) and the service teams (D) and then to communicate to the logger (B) that the necessary flow should be ensured with the said inventory. In one preferred embodiment of the invention, the notification server (4) is configured to initiate the log flow of the relevant service or inventory to the logger (B) by making the necessary integrations together with the information transmitted to the service owners (D).

### INDUSTRIAL APPLICABILITY OF THE INVENTION

With the inventive system (1), it is possible to detect log flow and cyber attacks carried out against services by extracting the lists of inventories that are unusable and/or invisible, upon identifying the critical inventories of organisations that are open to the Internet from a cyber security perspective and then to compare them with the inventories that are known to exist.

Within these basic concepts; it is possible to develop various embodiments of the inventive “Detection System (1) of Cyber Security Inventory”; the invention cannot be limited to examples disclosed herein and it is essentially according to claims.

1. A system (1) which is developed to detect log flow and cyber attacks carried out against services by extracting the lists of inventories that are unusable and/or invisible, upon identifying the critical inventories of enterprises that are open to the Internet from a cyber security perspective and then comparing them with the inventories that are known to exist; comprising
at least one scan server (2) which is configured to detect the services that are open to the Internet by performing scans outside the network (A) of the enterprise and to extract an inventory list;
characterized by
at least one detection server (3) which is configured to detect the services that provide log flow to the enterprise with the necessary queries from the logger (B) wherein all logs of the enterprise are collected;
at least one notification server (4) which is configured to compare the results received from the scan server (2) and the detection server (3), to detect the services that are running but not providing log streams, and to generate a notification to the owners of the related services (D) for necessary actions to be taken.

2. A system (1) according to claim 1; characterized by the scan server (2) which is configured to detect the services of the enterprise that are open to the Internet.

3. A system (1) according to claim 1; characterized by the scan server (2) which is configured to perform scans that detect open services according to the returned responses, by sending a connection request from an external server-that is independent of the enterprise and has internet access-such that it covers all ports included in the known IP range of the enterprise.

4. A system (1) according to claim 1, characterized by the scan server (2) which is configured to generate an inventory list based on the scans that detect open services according to the responses returned by the connection request that is sent to all ports included in the specified IP range.

5. A system (1) according to claim 1, characterized by the scan server (2) which is configured to obtain the findings of the scan in the form of names of servers of the enterprise that are open to the Internet such as web, e-mail.

6. A system (1) according to claim 1, characterized by the scan server (2) which is configured to transmit the findings obtained as a result of scans, to the detection server (3).

7. A system (1) according to claim 1, characterized by the detection server (3) which is configured to detect the services that provide log flow by making the necessary queries in the logger (B) wherein all logs of the enterprise are collected.

8. A system (1) according to claim 1, characterized by the detection server (3) which is configured to extract an inventory of the enterprise by making queries to the logger (B).

9. A system (1) according to claim 1, characterized by the detection server (3) which is configured to perform a cross-query together with the findings obtained by the scan server (2) and the information obtained by itself.

10. A system (1) according to claim 1, characterized by the detection server (3) which is configured to detect the missing points by comparing information received from the logger (B) with information from the scan server (2).

11. A system (1) according to claim l, characterized by the detection server (3) which is configured to make a mark, when a domain name such as “xyz. companyname. com” and a web server running behind it are detected as a result of the scans of the scan server (2) and when it does not detect this domain name in the information received over the logger (B).

12. A system (1) according to claim 1, characterized by the detection server (3) which is configured to transmit information to the notification server (4) for any service or inventory obtained as a result of the scan, but not found in the information received over the logger (B).

13. A system (1) according to claim 1, characterized by the detection server (3) which configured to transmit the information, transmitted from the detection server (3), to the security operations centre (C) and the service teams (D) and then to communicate to the logger (B) that the necessary flow should be ensured with the said inventory.

14. A system (1) according to claim 1, characterized by the detection server (3) which is configured to initiate the log flow of the relevant service or inventory to the logger (B) by making the necessary integrations together with the information transmitted to the service owners (D).
